(19) United States
(12) Patent Application Publication
(10) Pub. No.: US 2010/0075645 A1
(43) Pub. Date: Mar. 25, 2010

(54) MOBILE DEVICE AND LOCATION-INFORMATION NOTIFICATION METHOD

(75) Inventors: Kazuyuki Yamamura, Kawasaki (JP); Yuji Yamaji, Kawasaki (JP); Tomoki Iwabuchi, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/625,884

(22) Filed: Nov. 25, 2009

Related U.S. Application Data
(63) Continuation of application No. PCT/JP2007/063045, filed on Jun. 28, 2007.

(51) Int. Cl. H04W 4/02; H04M 3/42

(52) U.S. Cl. 455/415; 455/456.3

(57) ABSTRACT

A mobile phone A and a mobile phone B are in a call process and are capable of performing voice communication with each other. In such a state, the mobile phone A activates a GPS and acquires location information when an instruction to determine the location information about a location of the mobile phone A is received from an owner of the mobile phone A during a call process to the mobile phone B. Thereafter, the mobile phone A reads out aloud the acquired location information to audibly notify the mobile phone B using a voice communication line connected to the mobile phone B.

### CROSS-REFERENCE TO RELATED APPLICATION(S)

This application is a continuation of International Application No. PCT/JP2007/063045, filed on Jun. 28, 2007, the entire contents of which are incorporated herein by reference.

### FIELD

The embodiments discussed herein are directed to mobile devices that perform call processes with other mobile devices using voice communication, location-information notification methods, and location-information notification programs.

### BACKGROUND

Mobile terminals such as mobile phones that include a global positioning system (GPS) are becoming widely used, and location information such as a current location can be acquired in real time.

For example, Japanese Laid-open Patent Publication No. 2001-8254 discloses a technology in which location information is acquired using a first mobile phone, and the acquired location information is displayed on or audibly output to another mobile phone or a computer device that is connected to the first mobile phone. Specifically, the owner of the mobile phone acquires the location information of his/her mobile phone using a GPS or the like. The owner of the first mobile phone sends an image, a uniform resource locator (URL) linked to the image, audio reading of the screen, and so on as the acquired location information to the other device connected via the Internet or peer to peer (P2P) transfer by attaching the acquired location information to an email.

However, in conventional technology, there is a problem in that it is not easy to acquire the location information during a call process and it is not easy to notify a called party of this information.

Specifically describing the problem, when the location information is informed to the called party, the owner of the first mobile phone needs to view the screen, activate the GPS of the first mobile phone, and verbally inform the called party while viewing the location information acquired by the GPS or needs to end the call once, activate the GPS, and then send the location information acquired by the GPS by email. Accordingly, it is not easy for the owner of the mobile phone to inform the called party of the location information because the location information has to be given verbally or the call has to be ended once.

### SUMMARY

According to an aspect of an embodiment of the invention, a mobile device includes a location-information determining unit that determines location information of the mobile device during a call; and a location-information notification unit that notifies the determined location information to a destination device of the call.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram illustrating the outline and features of mobile phones according to a first embodiment;

FIG. 2 is a block diagram illustrating the configuration of a mobile phone A;

FIG. 3 is a schematic diagram illustrating an operation-instruction screen that is output to an output unit;

FIG. 4 is a flowchart illustrating a location-information notification process performed by the mobile phone A according to the first embodiment;

FIG. 5 is a schematic diagram illustrating an example screen that is displayed on an output unit of a mobile phone A according to a second embodiment;

FIG. 6 is a flowchart illustrating a location-information notification process for the mobile phone A according to the second embodiment; and

FIG. 7 is a block diagram illustrating an example of a computer system that executes a location-information notification program.

### DESCRIPTION OF EMBODIMENTS

Preferred embodiments of the present invention will be explained with reference to accompanying drawings. In the following description, main terms used in the embodiments, the outline and features of mobile phones according to the embodiments, the configuration of the mobile phones, and a flow of processing thereof are described in this order, and then various modifications of the embodiments are described.

### [a] First Embodiment

### Explanation of terms

First, main terms used in the embodiment are described. The mobile phone A and mobile phone B, which are mobile devices, used in the embodiment each represent a computer device that is capable of audibly communicating, and specifically corresponds to a personal computer or a workstation that is capable of audibly communicating, a game console for a home use, an internet TV, a mobile communication terminal such as a PDA or a PHS, and the like. Each of the mobile phone A and the mobile phone B has a GPS function and is capable of acquiring detailed location information using a GPS satellite.

Outline and Features of the Mobile Phones

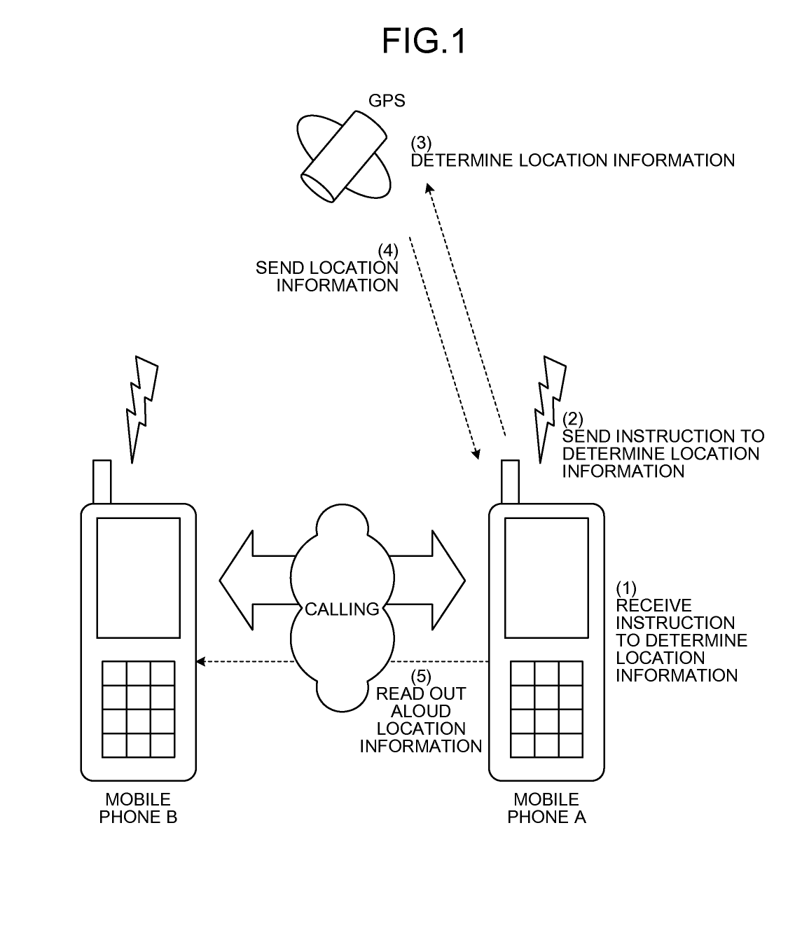

Next, the outline and features of the mobile phones according to the first embodiment are described with reference to FIG. 1. FIG. 1 is a schematic diagram illustrating the outline and features of the mobile phones according to the first embodiment. As illustrated in FIG. 1, the mobile phone A and the mobile phone B are devices capable of audibly performing a call process. In this specification, both mobile phones A and B are assumed to be already connected for voice communication.

With such a configuration, as described above, the mobile phone A performs the call process on the mobile phone B using voice communication, and, in particular, the mobile phone A has a feature in that it easily acquires the location information during the call process and easily notifies the called party of the location information.

The main features thereof are specifically described below. The mobile phone A determines the location information when an instruction to determine the location information about the location of the mobile phone A is received from the owner of the mobile phone A during the call process to the mobile phone B (see (1) to (4) in FIG. 1). Specifically, the mobile phone A receives, from the owner of the mobile phone A, the instruction to, for example, click a start button of a GPS function during the call process to the mobile phone B as the instruction to determine the location information about the location of the mobile phone A. Then, the mobile phone A activates the GPS function and starts determining the location information using a GPS satellite. The mobile phone A acquires the location information (for example, an email address such as Nakahara-ku, Kawasaki City, Kanagawa Prefecture . . . ) determined using the GPS satellite. The location information that can be acquired here includes cities, towns, and villages as well as the name of a station nearby the current location and information about nearby landmarks.

Thereafter, when the location information is determined by the GPS, the mobile phone A notifies the determined location information to the mobile phone B, which is the destination device in the call process (see (5) in FIG. 1). A specific explanation using the above-mentioned example is described. Using a voice communication line that is connected to the mobile phone B, the mobile phone A notifies the mobile phone B, which is the destination device in the call process, by reading out aloud the location information (Nakahara-ku, Kawasaki City, Kanagawa Prefecture) determined by the GPS.

In this way, with the mobile phone A according to the first embodiment, to acquire the current location information, there is no need for the owner of the mobile phone A to end the call process to the mobile phone B and no need to read aloud the acquired location information by himself or herself. Consequently, as the main futures described above, it is possible to easily acquire the location information during the call process and easily notify it to the called party.

Configuration of the Mobile Phone A

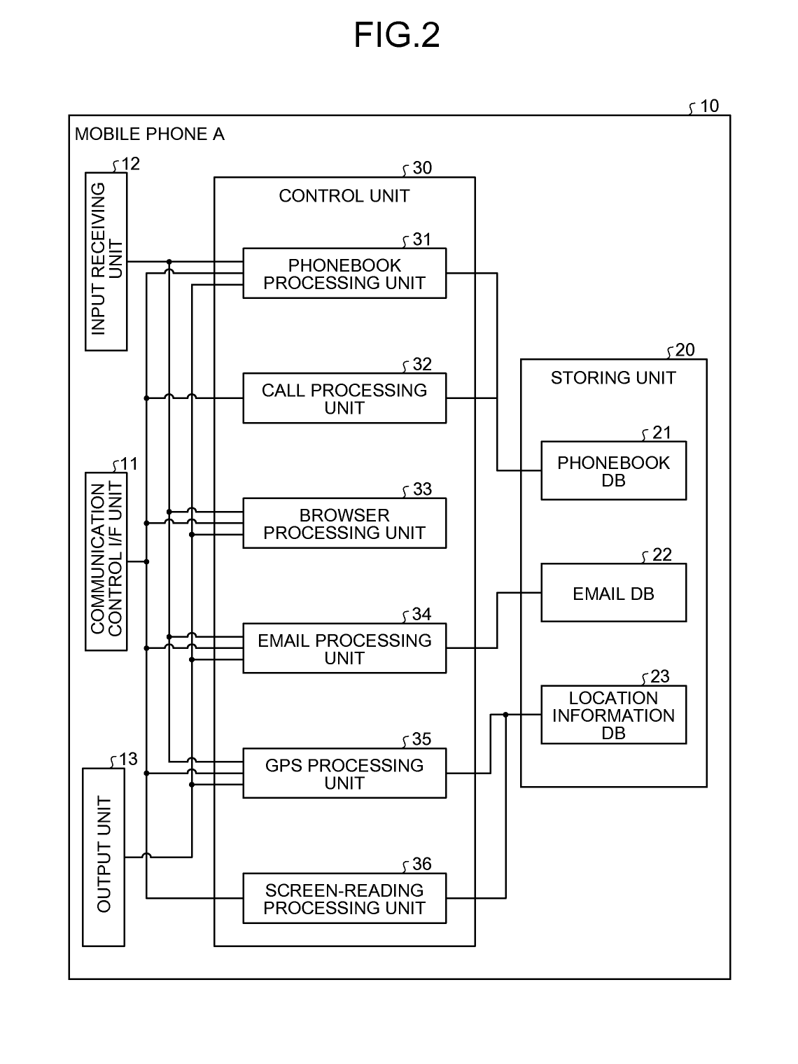

Next, the configuration of the mobile phone A illustrated in FIG. 1 is described with reference to FIG. 2. FIG. 2 is a block diagram illustrating the configuration of the mobile phone A. Because the mobile phone A and the mobile phone B have the same function, a detailed description is given only to the mobile phone A here.

As illustrated in FIG. 2, a mobile phone A 10 includes a communication control I/F unit 11, an input receiving unit 12, an output unit 13, a storing unit 20, and a control unit 30.

The communication control I/F unit 11 controls communication of various kinds of information exchanged with the other mobile phones or via the Internet. Specifically, the communication control I/F unit 11 controls various kinds of information about voice communication with the mobile phone B that is another mobile phone or various kinds of information about the internet communication or email communication connected using the later-described control unit 30.

The input receiving unit 12 includes a numeric keypad, a microphone, and the like and receives various kinds of information. For example, the input receiving unit 12 receives an instruction to determine the location information about the location of the mobile phone A from the owner of the mobile phone A and inputs data. When the input receiving unit 12 receives various kinds of operation instructions from the owner, the input receiving unit 12 notifies the control unit of the received operation instructions.

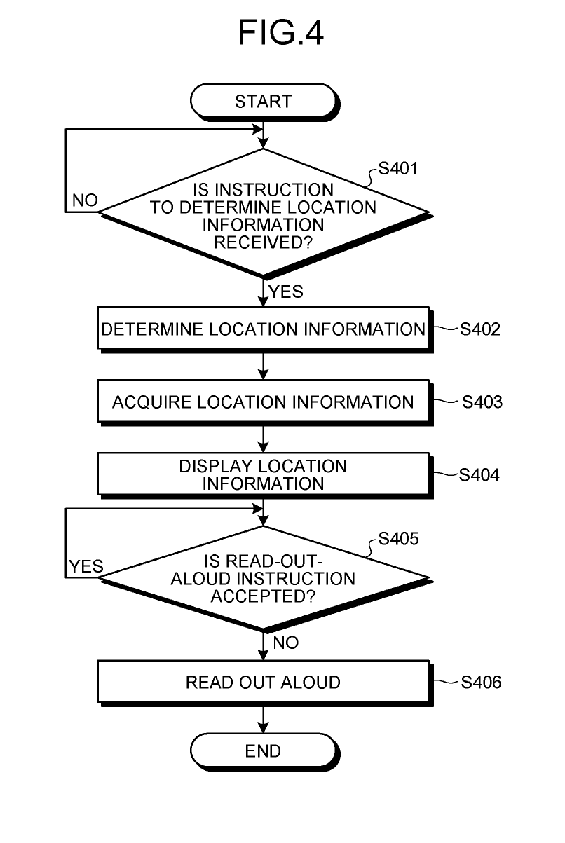

The output unit 13 includes a monitor (or a display or a touch panel) and a speaker and outputs various kinds of information. The output unit 13 displays, for example, location information acquired by the later-described control unit 30 as character data (for example, Nakahara-ku, Kawasaki City, Kanagawa Prefecture . . . ) or map data. In addition, the output unit 13 displays various types of screens to prompt the owner to select something (for example, see FIG. 4).

The storing unit 20 stores data and programs for various kinds of processes performed by the control unit 30 and includes a phonebook DB 21, an email DB 22, and a location information DB 23.

The phonebook DB 21 stores telephone numbers indicating call destinations and email addresses for sending and receiving emails. Specifically, the phonebook DB 21 stores, for example, “Tokkyo Taro, 03-XXX-XXXX, and tokkyo@a.com” corresponding to “a ‘name’ indicating the other party to be connected, a ‘telephone number’ of the other party for a call process, and an ‘email address’ indicating a destination email address”. The information containing various kinds of data and parameters indicated here can be arbitrarily changed unless otherwise noted.

The email DB 22 stores sent/received emails by associating them with sent/received dates and destinations. Specifically, the email DB 22 stores emails by sorting them into, for example, incoming, outgoing, and deleted items, each corresponding to “incoming email” for saving received emails, “sent email” for saving sent emails, and “trash box” for saving deleted emails. The information containing various kinds of data and parameters indicated here can be arbitrarily changed unless otherwise noted.

The location information DB 23 stores location information acquired using a later-described GPS processing unit 35. Specifically, the location information DB 23 stores the location information acquired by the GPS processing unit 35 as character data (for example, Nakahara-ku, Kawasaki City, Kanagawa Prefecture . . . ) or map data.

The control unit 30 has a control program such as an operating system (OS) and an internal memory for storing needed data and programs prescribing various kinds of procedures and also includes a phonebook processing unit 31, a call processing unit 32, a browser processing unit 33, an email processing unit 34, the GPS processing unit 35, and a screen-reading processing unit 36, which execute various kinds of processes.

The phonebook processing unit 31 registers telephone numbers in the phonebook DB 21 in response to instructions from the owner. Specifically, when the input receiving unit 12 receives an instruction to register a telephone number or an email address from the owner, the phonebook processing unit 31 registers, in the phonebook DB 21, the new telephone number or the new email address received from the owner by the input receiving unit 12. When the input receiving unit 12 receives an instruction to delete a telephone number or an email address from the owner, the phonebook processing unit 31 deletes the telephone number or the email address to be deleted from the phonebook DB 21. When the input receiving unit 12 receives an instruction to search for a telephone number or an email address from the owner, the phonebook processing unit 31 displays on the output unit 13 the telephone number or the email address stored in the phonebook DB 21.

The call processing unit 32 controls of connecting voice communication (call process) with another telephone apparatus. Specifically, using the telephone number stored in the phonebook DB 21, the call processing unit 32 performs a process for making a call to the telephone such as a mobile phone or an IP telephone associated with the telephone number or performs a process for receiving a call from another telephone.

The browser processing unit 33 performs various controls of browsers connected to the Internet. Specifically, when the input receiving unit 12 receives an instruction to connect to the Internet from the owner, the browser processing unit 33 activates an Internet-connection browser to connect to the Internet and downloads various kinds of information and the like.

The email processing unit 34 performs various controls of sending and receiving emails. Specifically, when the input receiving unit 12 receives an instruction to send an email from the owner, the email processing unit 34 sends the email created by the owner to the destination and stores the sent email in the email DB 22, and when emails are received from other devices, the email processing unit 34 stores the received emails in the email DB 22.

The GPS processing unit 35 determines location information when an instruction to determine the location information about the location of the mobile phone A 10 is received from the owner of the mobile phone A 10 during a call process to the other apparatus. Specifically, the GPS processing unit 35 determines the location information using the GPS when the instruction to determine the location information about the location of the mobile phone A 10 is received from the owner of the mobile phone A 10.

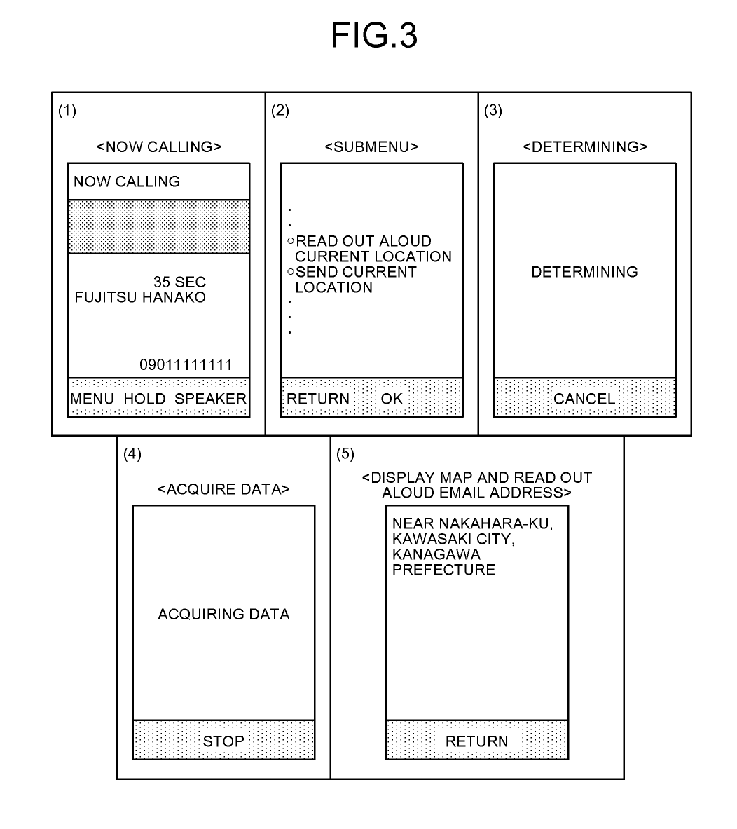

A specific description is given using various screens output from the output unit 13. As illustrated in (1) of FIG. 3, when the input receiving unit 12 receives an instruction to acquire the location information during the call process between the mobile phone A 10 and the mobile phone B, the GPS processing unit 35 displays the “submenu” screen illustrated in (2) of FIG. 3 on the output unit 13. When the owner selects the “read current location” displayed on the “submenu” screen, the GPS processing unit 35 displays the “determining” screen on the output unit 13, as illustrated in (3) FIG. 3, activates the GPS, and sends the instruction to acquire the location information to the GPS satellite. When the GPS satellite determines the location information and the mobile phone A 10 receives the determined location information, the GPS processing unit 35 in the mobile phone A 10 displays the “acquiring data” screen on the output unit 13 as illustrated in (4) of FIG. 3 and acquires the location information determined by the GPS satellite. Thereafter, the GPS processing unit 35 displays, as illustrated in (5) of FIG. 3, the acquired location information (for example, Nakahara-ku, Kawasaki City, Kanagawa Prefecture, or the like) on the output unit 13. The GPS processing unit 35 may be referred to as a “location-information determining unit”. Schematic diagrams illustrated in FIG. 3 are operation-instruction screens that are output to the output unit.

When the GPS processing unit 35 determines the location information, the screen-reading processing unit 36 notifies the called party's mobile phone B in the call process of the determined location information. Specifically, when the GPS processing unit 35 determines the location information (for example, Nakahara-ku, Kawasaki City, Kanagawa Prefecture, or the like), the screen-reading processing unit 36 reads out aloud the determined location information (for example, Nakahara-ku, Kawasaki City, Kanagawa Prefecture, or the like) to notify the called party's mobile phone B in the call process, using the same line connected for the call. The screen-reading processing unit 36 may be referred to as a “location-information notification unit”.

Processes Performed by the Mobile Phone A

Next, a process performed by the mobile phone A 10 is described with reference to FIG. 4. FIG. 4 is a flowchart illustrating a location-information notification process performed by the mobile phone A according to the first embodiment.

As illustrated in FIG. 4, when the input receiving unit 12 receives an instruction to determine the location information from the owner (Yes at Step S401), the GPS processing unit 35 in the mobile phone A 10 determines the location information about the location of the mobile phone A 10 using the GPS (Step S402).

The GPS processing unit 35 acquires the location information determined by the GPS satellite (Step S403) and displays the acquired location information (for example, character data, image data, and the like) on the output unit 13 (Step S404).

Thereafter, the screen-reading processing unit 36 reads out aloud the determined location information to audibly notify the called party's mobile phone B in the call process, using the same line connected for the call (Yes at Step 5405 and Step S406).

### Advantage of the First Embodiment

In this way, according to the first embodiment, because the location information about the location of the mobile device is determined during the call process to the mobile phone B and during the phone conversation, and the determined location information is notified to the mobile phone B, which is the destination device of the call, it is possible to easily acquire the location information during the call process and easily notify the called party.

For example, to acquire the current location information, because there is no need for the owner of the mobile phone A to end the call process to the mobile phone B and no need to read out aloud the acquired location information by himself or herself, it is possible to easily acquire the location information during the call process and easily notify the called party.

Furthermore, according to the first embodiment, when an instruction to determine the location information about the location of the mobile phone A 10 is received from the owner of the mobile phone A 10, because the location information is determined using the GPS, accurate location information can be acquired.

Furthermore, according to the first embodiment, when the location information is determined, because the determined location information is read out aloud to audibly notify the called party's mobile phone B in the call process, the location information can be accurately informed of the called party in a simple notification manner.

### [b] Second Embodiment

In the first embodiment, a case in which the determined location information is read out aloud to audibly notify to the mobile phone B that is connected for the call is described; however, the present invention is not limited thereto. It is possible to notify the mobile phone B connected to the call by email.

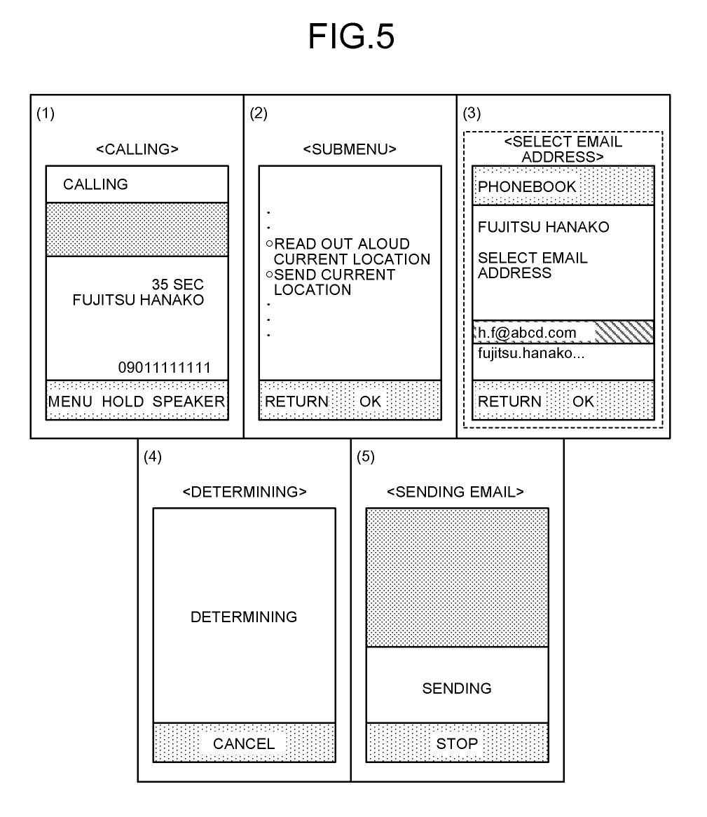

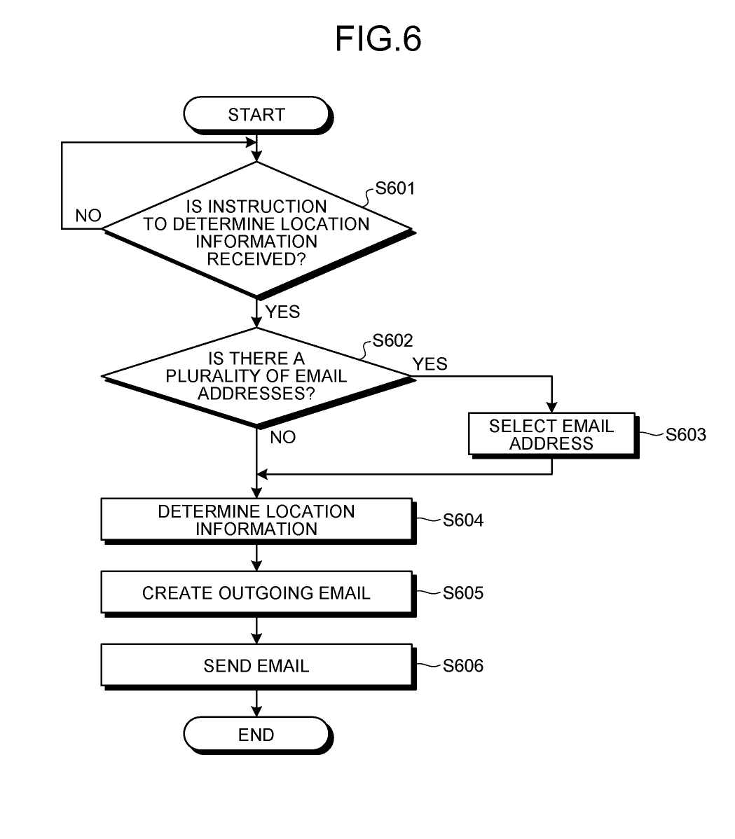

In a second embodiment, a case in which the determined location information is notified to the mobile phone B connected for the call by email is described with reference to FIGS. 5 and 6. In the second embodiment, similar to the first embodiment, the mobile phone A and the mobile phone B are in call processes each other. First, the outline of the mobile phone A according to the second embodiment is described with reference to FIG. 5, and next, a flow of a location information notification for the mobile phone A according to the second embodiment is described with reference to FIG. 6.

### Outline of the Mobile Phone a According to the Second Embodiment

FIG. 5 is schematic diagrams illustrating example screens that are displayed on the output unit of the mobile phone A according to the second embodiment. As illustrated in (1) of FIG. 5, when the input receiving unit 12 receives an instruction to acquire the location information during the call process between the mobile phone A and the mobile phone B, the mobile phone A according to the second embodiment displays the “submenu” screen illustrated in (2) of FIG. 5 on the output unit 13. When the owner selects the “send current location” on the “submenu” screen, as illustrated in (3) of FIG. 5, the mobile phone A displays an email address of the mobile phone B that is connected for the call. If a plurality of email addresses are displayed, the mobile phone A receives the email address selected by the owner or automatically selects the email address of the currently connected terminal by referring to a domain name.

When the email address is automatically selected or selected by the owner, as illustrated in (4) of FIG. 5, the mobile phone A displays the “determining” screen on the output unit 13, activates the GPS, and sends an instruction to acquire the location information to the GPS satellite. Thereafter, when the GPS satellite determines the location information and when the determined location information is sent to the mobile phone A, as illustrated in (5) of FIG. 5, the mobile phone A sends an email, by attaching the acquired location information, to the mobile phone B as the destination whose email address is selected in (3) of FIG. 5.

In this way, when the location information is determined by the GPS, the mobile phone A according to the second embodiment can notify the determined location information to the called party's mobile phone B that is in the call process by email by attaching the determined location information to the email.

Flow of a Location Information Notification Process

FIG. 6 is a flowchart illustrating a location-information notification process for the mobile phone A according to the second embodiment. As illustrated in FIG. 6, when an instruction to determine the location information is received from the owner (Yes at Step S601), the mobile phone A 10 determines whether a plurality of email addresses of the mobile phone B, which is a call destination, are stored in the phonebook DB 21 (Step S602).

If the plurality of email addresses of the mobile phone B are stored in the phonebook DB 21 (Yes at Step S602), the mobile phone A displays the stored plurality of email addresses, receives the email address selected by the owner (Step S603), and determines the location information about the location of the mobile phone A 10 using the GPS (Step S604).

On the other hand, if the plurality of email addresses of the mobile phone B is not stored in the phonebook DB 21 (No at Step S602), the mobile phone A determines the location information about the location of the mobile phone A 10 using the GPS (Step S604).

The mobile phone A creates an outgoing email to which the location information determined by the GPS satellite is attached (Step S605) and sends the created outgoing email to the mobile phone B, which is the destination of the email (Step S606).

### Advantage of the Second Embodiment

In this way, when the location information is determined by the GPS, because the mobile phone A according to the second embodiment notifies, by email, the mobile phone B, which is the destination device in the call process, of the determined location information by attaching it to the email, the location information can be accurately informed of the called party in a simple notification manner.

### [c] Third Embodiment

Although embodiments of the present invention are described in the above embodiments, embodiments other than those described above can be applied to the present invention. Therefore, as described below, another embodiment is described in the following categories: (1) device to be notified, (2) method of determining, (3) method of notification, (4) system configuration, etc., and (5) programs.

(1) Device to be Notified

In the above embodiments, a case in which the location information indicating the current location is notified to the other party when performing two-way communication is described; however, the present invention is not limited thereto. Even when performing three-way communication, notification can be given in a similar manner. In that case, the location information indicating the current location is audibly notified or notified by email to other telephones simultaneously except for the owner's device that is currently in a call process.

(2) Method of Determining

In the first embodiment, a case in which the location information is determined/acquired using the GPS is described; however, the present invention is not limited thereto. For example, location information determined by a nearby base station can be acquired. Specifically, when the mobile phone A receives an instruction to determine the location information about the location of the mobile device from the owner of the mobile device, the mobile phone A sends an instruction to determine the location information to a nearby base station. When the determined location information is received from the base station, the mobile phone A notifies the acquired location information to the mobile phone B of the call destination.

The location information to be determined also includes the address of the location in which the mobile phone is currently located, the name of a nearby station, and nearby landmarks. For example, the owner sets in advance which information is acquired, and the mobile phone can acquire the location information on the basis of the information that is set. In addition to acquiring the location information when the instruction to determine the location information is received from the owner, the location information can be automatically acquired upon starting the call.

(3) Method of Notification

In the first embodiment, a case in which the acquired location information is read out aloud and audibly notified is described, and in the second embodiment, a case in which the acquired location information is notified to the mobile phone in the call process B by email as character data is described; however, the present invention is not limited thereto. For example, the URL representing data on the acquired location information or map data itself can be sent by attaching it to the email. By doing so, the location information can be accurately informed of the called party in a simple notification manner.

(4) System Configuration, Etc.

Of the processes described in the embodiment, the whole or a part of the processes that are mentioned as being automatically performed (for example, sending/receiving email, etc.) can be manually performed, or the whole or a part of the processes that are mentioned as being manually performed (for example, an instruction to acquire the location information, etc.) can be automatically performed using known methods. Furthermore, the process procedures, the control procedures, the specific names, and the information containing various kinds of data or parameters indicated in the above specification and drawings can be arbitrarily changed unless otherwise noted.

The components of the devices illustrated in the drawings are only for conceptually illustrating the functions thereof and are not necessarily physically configured like that illustrated in the drawings. In other words, the specific shape of a separate or integrated device is not limited to the drawings; however, the whole or a part of the device can be configured by functionally or physically separating or integrating any units according to various loads or use conditions.

(5) Program

The various kinds of processes described in the above embodiment can be implemented by executing programs prepared in advance using a computer system such as a personal computer or a workstation. A computer system that executes programs having similar functions as the above-mentioned embodiment is described below as another embodiment.

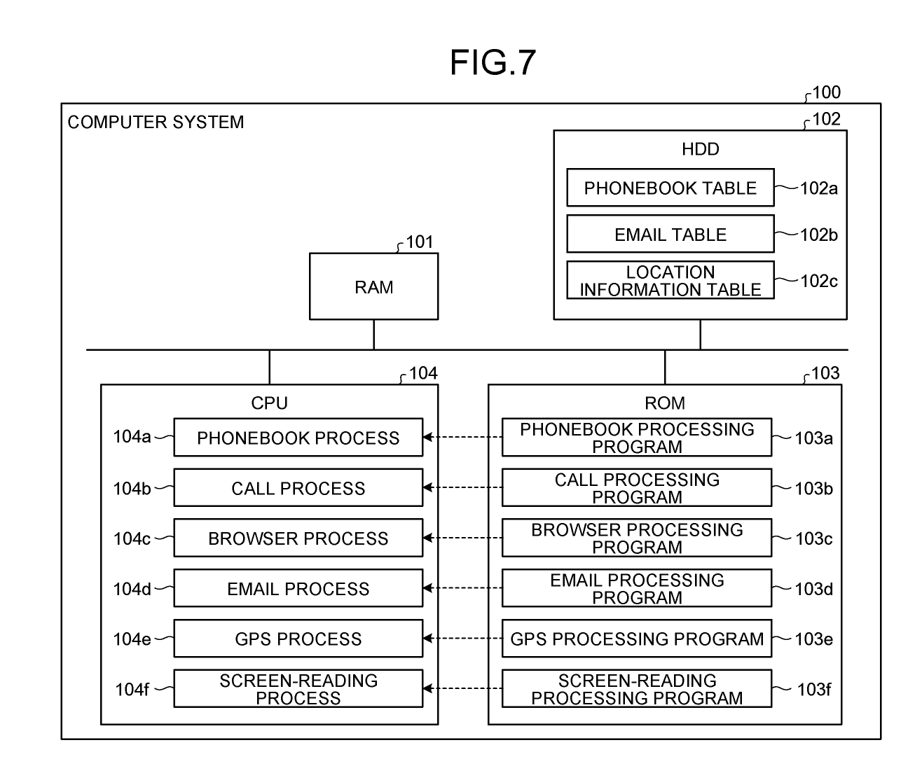

FIG. 7 is a block diagram illustrating an example of the computer system that executes a location-information notification program. As illustrated in FIG. 7, a computer system 100 includes a RAM 101, an HDD 102, a ROM 103, and a CPU 104. The ROM 103 stores, in advance, programs exhibiting the same function as the above-described embodiment, i.e., as illustrated in FIG. 7, a phonebook processing program 103a, a call processing program 103b, a browser processing program 103c, an email processing program 103d, a GPS processing program 103e, and a screen-reading processing program 103f.

As illustrated in FIG. 7, by reading and executing these programs 103a to 103f, the CPU 104 functions as a phonebook process 104a, a call process 104b, a browser process 104c, an email process 104d, a GPS process 104e, and a screen-reading process 104f. The phonebook process 104a corresponds to the phonebook processing unit 31 illustrated in FIG. 2. Similarly, the call process 104b corresponds to the call processing unit 32, the browser process 104c corresponds to the browser processing unit 33, the email process 104d corresponds to the email processing unit 34, the GPS process 104e corresponds to the GPS processing unit 35, and the screen-reading process 104f corresponds to the screen-reading processing unit 36.

The HDD 102 includes a phonebook table 102a that stores telephone numbers indicating call destinations or email addresses for sending/receiving emails; an email table 102b that stores sent/received emails in association with sent/received dates and destinations; and a location information table 102c that stores the acquired location information. The phonebook table 102a corresponds to the phonebook DB 21 illustrated in FIG. 2, the email table 102b corresponds to the email DB 22, and the location information table 102c corresponds to the location information DB 23.

The above-described programs 103a to 103f are not necessarily stored in the ROM 103. For example, they can be stored in a “portable physical medium” such as a flexible disk (FD), a CD-ROM, a magneto-optical disk, a DVD disk, an IC card, and the like that can be inserted into the computer system 100; a “fixed physical medium” such as a hard disk drive (HDD) that can be arranged inside/outside the computer system 100; and “another computer system” connected to the computer system 100 via a public circuit, the Internet, a LAN, a WAN, and the like and then the computer system 100 reads and executes the programs from the above.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A mobile device comprising:
a location-information determining unit that determines location information of the mobile device during a call; and
a location-information notification unit that notifies the determined location information to a destination device of the call.

2. The mobile device according to claim 1, wherein, when a call process for the destination device is performed, the location-information determining unit determines the location information without receiving an instruction to determine the location information of the mobile device from an owner of the mobile device.

3. The mobile device according to claim 1, wherein, when an instruction to determine the location information of the mobile device is received from an owner of the mobile device, the location-information determining unit determines the location information using a GPS or a nearby base station.

4. The mobile device according to claim 1, wherein, when an instruction to determine the location information of the mobile device is received from an owner of the mobile device, the location-information determining unit determines the location information including information about an address, a name of a nearby station, and a nearby landmark of a current location of the mobile device.

5. The mobile device according to claim 1, wherein, when the location-information determining unit determines the location information, the location-information notification unit reads out aloud the determined location information to audibly notify the destination mobile device in the call process.

6. The mobile device according to claim 1, wherein, when the location-information determining unit determines the location information, the location-information notification unit sends an email to which the determined location information is attached to the destination mobile device in the call process.

7. The mobile device according to claim 1, wherein, when the location-information determining unit determines the location information, the location-information notification unit sends an email to which a uniform resource locator indicating the determined location information is attached to the destination mobile device in the call process.

8. The mobile device according to claim 1, wherein, when the location-information determining unit determines the location information, the location-information notification unit sends an email to which map data indicating the determined location information is attached to the destination mobile device in the call process.

9. A method for notifying location information, suitable for performing a call process between a mobile device and a destination mobile using voice communication, the method comprising:
in response to an instruction to determine the location information of the mobile device from an owner of the mobile device in the call process, determining location information of the mobile device; and
notifying the determined location information to a destination device of a call in the call process.

10. A computer readable storage medium having stored therein a program for a call process between a mobile device and a destination mobile using voice communication, the program causing a computer to execute a process comprising:
in response to an instruction to determine the location information of the mobile device from an owner of the mobile device in the call process, determining location information of the mobile device; and
notifying the determined location information to a destination device of a call in the call process.
